(19) United States
(12) Patent Application Publication
(10) Pub. No.: US 2009/0027544 A1
(43) Pub. Date: Jan. 29, 2009

(54) SOLID STATE OPTICAL MOTION COMPENSATION

(75) Inventor: Roopinder Singh Grewal, San Jose, CA (US)

Correspondence Address: RatnerPrestia, P.O. BOX 980, VALLEY FORGE, PA, 19482, US

(73) Assignee: Micron Technology, Inc., Boise, ID (US)

(21) Appl. No.: 11/782,779

(22) Filed: Jul. 25, 2007

(51) Int. Cl. G03B 13/00

(52) U.S. Cl. 348/352

(57) ABSTRACT

Methods and systems for capturing an image. Light is received through an imaging lens that has an adjustable focal center. A motion vector representing motion of the imaging lens is estimated and a shift vector is estimated in response to the motion vector. The shift vector is converted into a voltage gradient and provided to the imaging lens. The voltage gradient shifts the focal center of the imaging lens to compensate for the motion of the imaging lens.

### FIELD OF THE INVENTION

The present invention relates to the field of imagers and, more particularly, to methods and systems for capturing an image using an imaging lens adjustable in response to detected motion.

### BACKGROUND OF THE INVENTION

Image sensors find applications in a wide variety of fields, including machine vision, robotics, guidance and navigation, automotive applications and consumer products. In many smart image sensors, it is desirable to integrate on chip circuitry to control the image sensor and to perform signal and image processing on the output image. Charge-coupled devices (CCDs), which have been one of the dominant technologies used for image sensors, however, do not easily lend themselves to large scale signal processing and are not easily integrated with complimentary metal oxide semiconductor (CMOS) circuits.

CMOS image sensors may be used in imaging systems, for example, a camera system, a vehicle navigation system, or an image-capable mobile phone. Imaging systems may be subjected to motion that typically produces a blurred image if image stabilization techniques, such as motion compensation, are not used. For example, the human hand tends to shake to a certain degree. Hand shake motion may produce a blurred picture when taking pictures without using a tripod, depending upon an exposure time of the image.

Digital cameras typically include image stabilization systems, such as gyroscopes to track the hand shake and motors to adjust the lens position to correct for hand shake. For example, see U.S. Pat. No. 7,061,688 to Sato et al. entitled “Zoom Lens with a Vibration-Proof Function.” Image sensors that are integrated into imaging systems, such as mobile phones, typically do not include a mechanically adjustable lens. In addition, because mobile phones are typically lighter in weight than digital cameras, mobile phones may generally be more susceptible to motion. Furthermore, because some imaging systems typically operate in a low light environment without a flash, an exposure time of the image is longer, thus providing more opportunity for motion to blur the resulting image.

### BRIEF DESCRIPTION OF THE DRAWINGS

FIG. 1 is a block diagram of a motion adjustment system according to an embodiment of the invention.

FIG. 2A is a side view diagram of an adjustable lens shown in FIG. 1, illustrating voltage gradients applied to the adjustable lens, according to an embodiment of the invention.

FIG. 2B is a top view diagram of the adjustable lens illustrating electrical contacts for applying the voltage gradients, according to an embodiment of the invention.

FIG. 3A is a side view diagram of a portion of the adjustable lens illustrating transmission of incident light through the adjustable lens responsive to an electric field.

FIG. 3B is a side view diagram of the portion of the adjustable lens illustrating a redirection of incident light through the adjustable lens and a shifting of the focal center in response to the applied voltage gradients, according to an embodiment of the invention.

FIG. 3C is a top view diagram illustrating a shift in the focal center of a virtual lens in X and Y directions resulting from the applied voltage gradients, according to an embodiment of the invention.

FIG. 4 is a flow chart illustrating a method for generating and shifting a focal center of a virtual lens to compensate for motion, according to an embodiment of the invention.

FIG. 5 is a block diagram of an image sensor including the adjustable lens shown in FIGS. 2A and 2B.

FIG. 6 is a block diagram of a processing system incorporating at least one imaging device including a motion adjustment system constructed in accordance with an embodiment of the invention.

### DETAILED DESCRIPTION OF THE INVENTION

In the following detailed description, reference is made to the accompanied drawings which form a part hereof, and which illustrates specific embodiments of the present invention. These embodiments are described in sufficient detail to enable those of ordinary skill in the art to make and use the invention. It is also understood that structural, logical or procedural changes may be made to the specific embodiment disclosed without departing from the spirit and scope of the present invention.

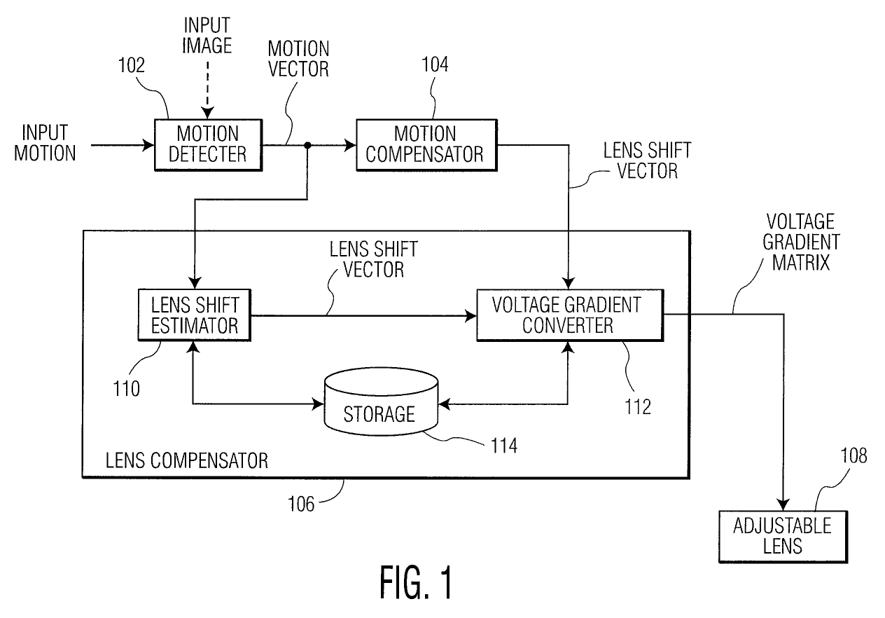

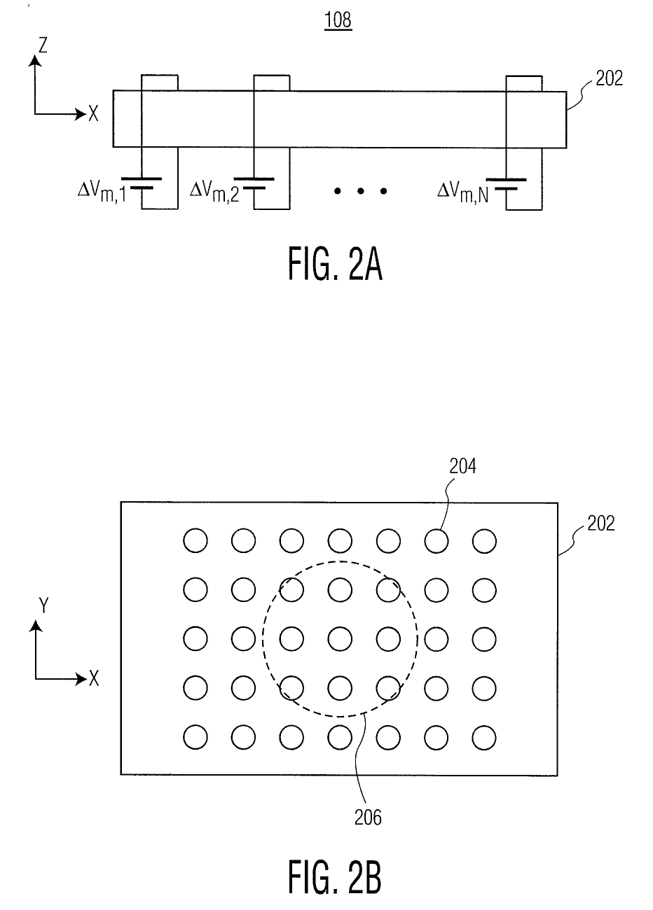

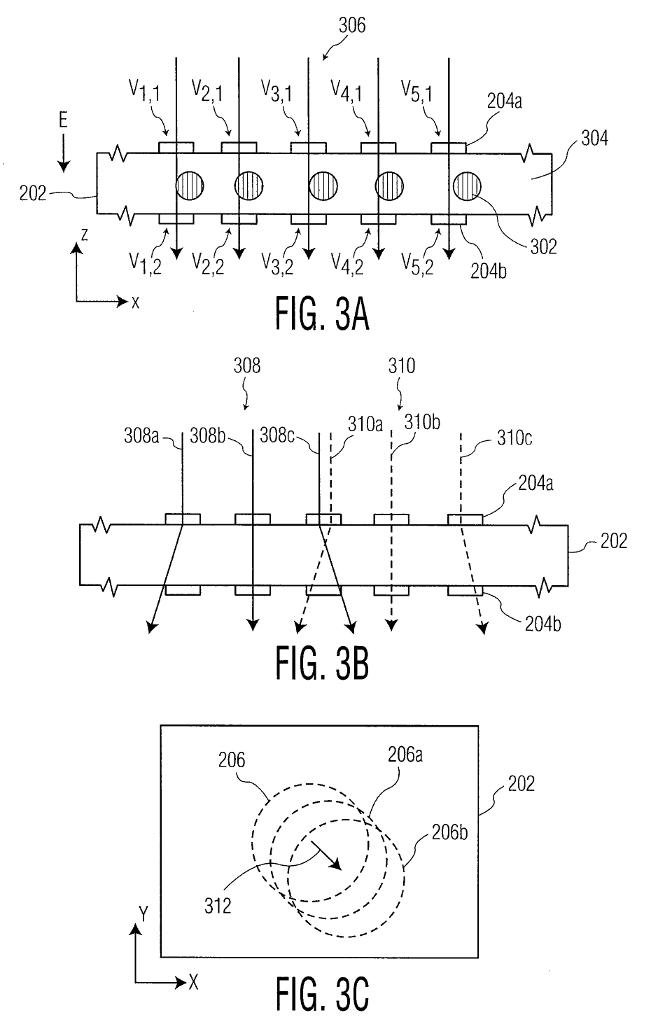

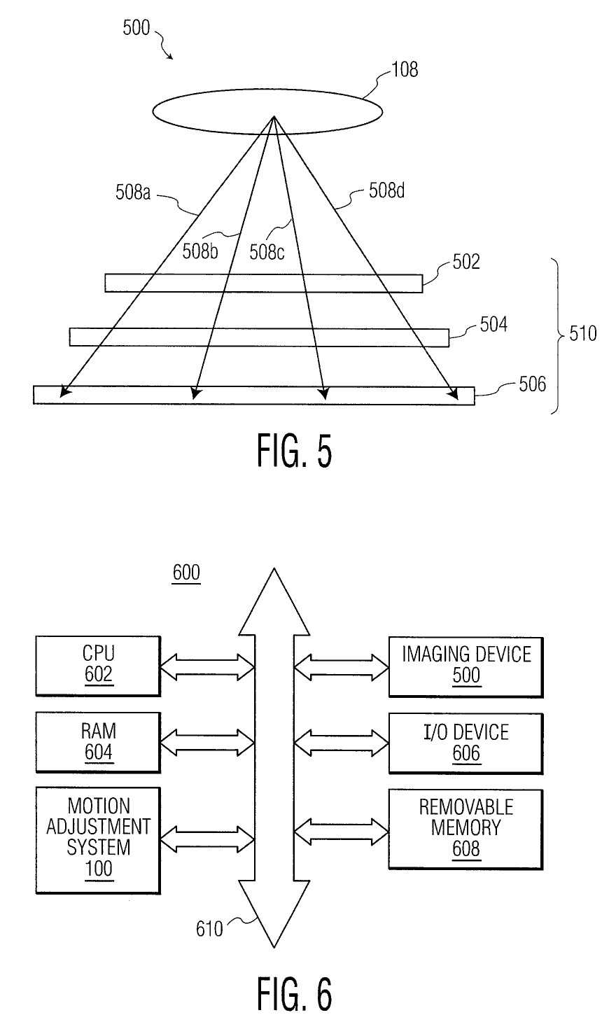

FIG. 1 illustrates a block diagram for a motion adjustment system, designated generally as 100, and used with an imaging device such as imaging device 500 (FIG. 5) as part of imaging system 600 (FIG. 6). Motion adjustment system 100 includes motion detector 102, lens compensator 106 and adjustable lens 108. Adjustable lens 108, described below with respect to FIGS. 2A-3C, is an imaging lens configured to generate virtual lens 206 and shift a focal center of virtual lens 206 (FIG. 2B) responsively to an applied voltage gradient matrix. Motion adjustment system 100 may optionally include motion compensator 104 configured to determine a lens shift vector based on a motion vector received from motion detector 102.

Motion detector 102 is configured to receive input motion associated with motion in X and Y directions of an imaging system and determine its motion vector. The input motion may include rotation, translation or any combination thereof. Motion detector 102 may also be configured to detect motion in a Z direction of the imaging system and determine its motion vector. Motion in the Z direction may be determined, for example, in order to adjust a focal point of adjustable lens 108, described further below. As used herein, the X and Y directions correspond to lens axes that are parallel to an image plane and the Z direction corresponds to a lens axis that is perpendicular to the image plane. Motion detector 102 may include, for example, an accelerometer or a gyroscope or any motion sensing device that is capable of measuring acceleration, velocity, position or any combination thereof corresponding to motion in the X and Y directions. For example, see U.S. Pat. No. 7,104,129 to Nasiri et al. entitled “Vertically Integrated MEMS Structure with Electronics in a Hermetically Sealed Cavity.” It is understood that any suitable device capable of measuring motion and determining a corresponding motion vector may be used.

In one embodiment, motion detector 102 may determine whether the input motion is greater than a motion threshold. If the input motion is less than or equal to the motion threshold, motion detector 102 may instruct lens compensator 106 to use a previously determined voltage gradient matrix.

Motion in the X and Y directions may be estimated and translated into a motion vector indicating magnitude and direction of motion during a particular interval. It is understood that the estimated motion may be obtained from integration of linear or angular acceleration or velocity. In another embodiment, motion detector 102 may be configured to receive a number of input images in a sequence, for example, from image processor 620 (FIG. 6). Motion detector 102 may correlate the number of images to identify motion in X and Y directions and to generate a corresponding motion vector.

In a further embodiment, a combination of motion detection (from motion sensors) and image correlation (from a number of images) may be used to determine a corresponding motion vector. Motion detector 102 may include electronic components and any software suitable for generating a corresponding motion vector.

Lens compensator 106 is configured to receive a motion vector from motion detector 102 and, in response, generate a voltage gradient matrix. Lens compensator 106 may include lens shift estimator 110 configured to receive a motion vector, voltage gradient converter 112 configured to receive a lens shift vector and storage 114.

Len shift estimator 110 and voltage gradient converter 112 may include a processor, to respectively, determine a lens shift vector and voltage gradient matrix. Storage 114 may include, for example, a memory or a magnetic disk. Storage 114 may store, for example, an estimated motion vector, an estimated lens shift vector and/or a generated voltage gradient matrix. Lens compensator 106 may also include electronic components and any software suitable for determining the lens shift vector and generating the voltage gradient matrix.

The lens shift vector represents a shift in the focal center of virtual lens 206 (FIG. 2B), in the X-direction, Y-direction or any combination thereof, in order to compensate for the detected input motion. In one embodiment, lens shift estimator 110 is configured to receive a motion vector and estimate a lens shift vector to compensate for the input motion based on a predetermined relationship between the motion vector and a desired motion compensation. The predetermined relationship may include the response time of adjustable lens 108 to respond to the voltage gradient matrix, the focal point and size of virtual lens 206 (FIG. 2B), and the amount of change in the motion vector over an interval of time. In another embodiment, lens shift estimator 110 may estimate a lens shift vector from a look-up table stored in storage 114. In a further embodiment, lens shift estimator 110 may be configured to predict the input motion from previous multiple motion vectors stored in storage 114. The lens shift estimator 110 may determine that a change in the motion vector from a previous motion vector is less than a predetermined threshold and maintain the previously generated voltage gradient matrix to adjustable lens 108.

Voltage gradient converter 112 is configured to apply a voltage gradient matrix based on the size of virtual lens 206 and whether virtual lens 206 is a negative or positive lens. Voltage gradient converter 112 receives the lens shift vector and converts the lens shift vector to a voltage representing a shift in the focal center of virtual lens 206, as described below with respect to FIGS. 2A-3C.

Voltage gradient converter 112 may use a predetermined relationship between the lens shift vector and parameters of virtual lens 206 to determine the voltage gradient matrix. In another embodiment, voltage gradient converter 112 may use a look-up table to convert the lens shift vector to the voltage gradient matrix. It is understood that any suitable method for converting a lens shift vector to a voltage gradient matrix may be used to shift the focal center of adjustable lens 108.

Motion adjustment system 100 may include motion compensator 104 configured to receive the motion vector and estimate a lens shift vector, in a manner similar to the lens shift vector estimated by lens shift estimator 110, and described above. If motion compensator 104 is included in motion adjustment system 100, voltage gradient converter 112 may receive the lens shift vector directly from motion compensator 104.

Referring now to FIGS. 2A-3C, adjustable lens 108 includes lens material 202 configured to produce virtual lens 206, where virtual lens 206 may be shifted responsively to a voltage gradient matrix, ΔV_{m,n}. FIG. 2A is a side view of adjustable lens 108 illustrating voltage gradients applied to lens material 202; FIG. 2B is a top view of adjustable lens 108 illustrating electrical contacts for applying the voltage gradients; FIG. 3A is a side view of a portion of lens material 202 illustrating transmission of incident light responsive to an electric field; FIG. 3B is a side view of the lens material 202 illustrating a redirection of incident light and a shifting of the focal center in response to the applied voltage gradients; and FIG. 3C is a top view illustrating a shift in the focal center of virtual lens 206 along direction 312 resulting from the applied voltage gradients.

The voltage gradient matrix may generally be represented as ΔV_{m,n}, where m represents voltage gradients along the x direction and n represents voltage gradients along the y direction. As shown in FIG. 2A, at index m, a voltage gradient of {ΔV_{m,1}, ΔV_{m,2}, . . . , ΔV_{m,N}} is applied in the x direction to lens material 202, i.e. for row m of contacts 204 (not shown in FIG. 2A). As shown in FIGS. 2B, 3A and 3B, contacts 204 are arranged at opposing faces of lens material 202 to receive the respective voltage gradients from the voltage gradient matrix.

Any suitable number and arrangement of contacts 204 on opposing faces of lens material 202 may be used, according to the parameters of virtual lens 206 and a desired shift of the focal center. Although FIG. 2B illustrates a rectangular, regularly spaced arrangement of contacts 204, it is understood that any other suitable arrangement of contacts 204 may be provided, including irregularly spaced arrangements. Although in one embodiment, contacts 204 are indium-tin-oxide (ITO), it is understood that any suitable material may be used.

Referring to FIG. 3A, lens material 202 includes particles 302 in a polymer matrix 304, where particles 302 may be reoriented with an applied directional electric field (E). A substantially similar voltage may be applied to contacts 204a and 204b of adjustable lens 108, where the index for row m is not shown. In FIG. 3A, V_{1,1} and V_{1,2} represent the voltages applied to pair of contacts 204a, 204b corresponding to ΔV_{m,1} of FIG. 2A. Because each of the voltages applied to respective contacts 204a, 204b is substantially the same (i.e. the voltage gradient is approximately 0 V), particles 302 are reoriented to a single directional electric field E. Light rays 306 are then transmitted through material 202 in a substantially similar direction.

If different voltages are applied between contacts 204a and 204b, multiple directional electric fields are formed and particles 302, within corresponding regions of lens material 202, are also reoriented according to the multiple directional electric fields. The applied voltage gradient matrix, thus, changes the direction of light transmitted through lens material 202, and may be configured to form a positive or a negative lens having a predetermined focal point. Accordingly, as shown in FIGS. 3B and 3C, voltage gradients are applied to generate a virtual lens 206 as a negative lens and shifting the center of virtual lens 206. Although not shown, a positive lens may also be formed by applying an appropriate voltage gradient matrix.

In one embodiment, material 202 includes a polymer-dispersed liquid crystal (PDLC) having liquid crystal (LC) droplets dispersed in a polymer matrix that is randomly oriented. The LC droplets are capable of being reoriented along the electric field direction. For example, a PDLC is described by Ren et al. in “Polarization-independent phase modulation using a polymer-dispersed liquid crystal,” Applied Physics Letters 86, 141110 (2005). It is contemplated that any suitable material capable of controlling the direction of transmission of incident light through the material responsive to voltage gradients may be used.

In FIG. 3B, for a set of incident light rays 308a-308c, a voltage gradient matrix is applied to contacts 204a, 204b such that light rays 308a-308c are transmitted and redirected through the material. In this manner, virtual lens 206 is formed with a focal center approximately corresponding to light ray 308b. Another voltage gradient matrix is applied to contacts 204a, 204b for a set of incident light rays 310a-c. Thus, the focal center is shifted in the X-direction from light ray 308b to approximately correspond to light ray 310b.

In FIG. 3C, the voltage gradient matrix is applied so that virtual lens 206 is shifted in direction 312 to provide virtual lenses 206a and 206b that correspond to respective lens shift vectors estimated by lens compensator 106 or, optionally, motion compensator 104. Accordingly, adjustable lens 108 provides a shift in the focal center without changing a physical shape of the lens. Although described with respect to a shift in the focal center, it is understood that the voltage gradient matrix may also be applied so that the focal point of the adjustable lens 108 is varied, for example, in response to detected motion in the Z direction, to provide a focusing adjustment.

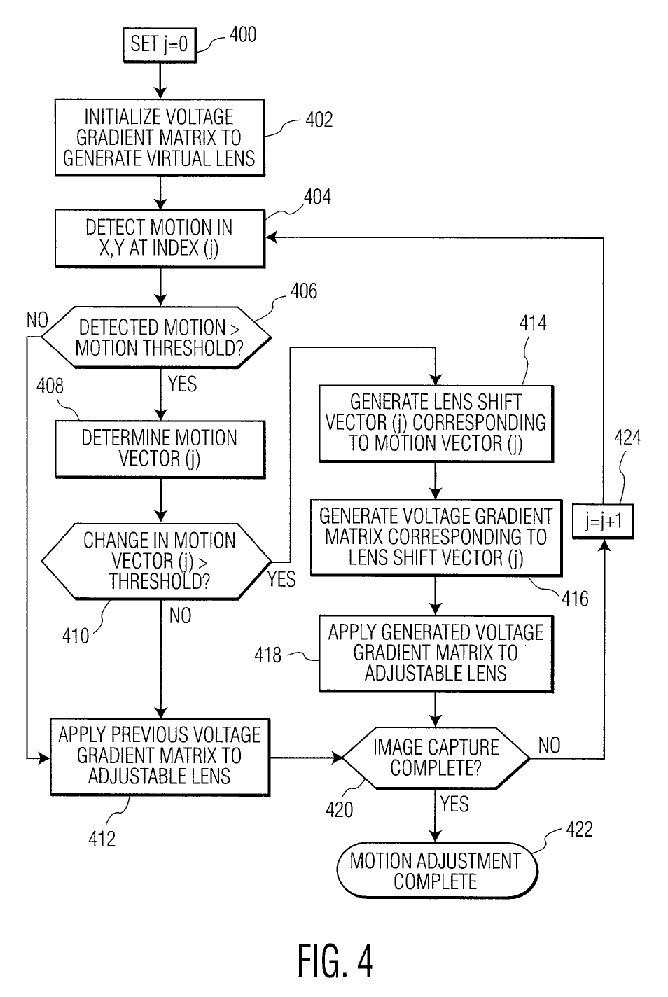

FIG. 4 is flow chart illustrating a method for generating virtual lens 206 in adjustable lens 108 to compensate for motion, according to an embodiment of the invention. The steps illustrated in FIG. 4 merely represent an embodiment of the present invention. It is understood that certain steps may be eliminated or performed in an order different from what is shown.

In step 400, index j is initialized, for example as j=0. Index j may correspond to a time index, an image frame index or any suitable index for adjusting a lens to compensate for motion over time. In step 402, an initial virtual lens 206 (FIG. 2B) and initial focal center is determined and a corresponding voltage gradient matrix is generated.

In step 404, motion is detected in the X,Y directions at index j, for example, by motion detector 102 (FIG. 1). In step 406, it is determined whether the detected motion is greater than a motion threshold. If the detected motion is greater than the motion threshold, step 406 proceeds to step 408 to determine a motion vector. If it is determined that the detected motion is less than or equal to the motion threshold, however, step 406 proceeds to step 412 and a previously determined voltage gradient matrix is applied to adjustable lens 108 (FIG. 1). Step 406 may be performed in addition to, or alternatively to, step 404.

In step 408, the motion vector at index j is determined from the detected motion. In step 410, it is determined whether a change in the motion vector is greater than a threshold, for example, by lens compensator 106 or optionally by motion compensator 104 (FIG. 1). If the change in the motion vector is greater than the threshold, step 410 proceeds to step 414 to determine a lens shift vector.

If it is determined that the change in motion vector is less than or equal to the threshold, on the other hand, step 410 proceeds to step 412 and a previously generated voltage gradient matrix is applied to adjustable lens 108, for example, by lens compensator 106 or optionally by motion compensator 104 (FIG. 1). Step 412 proceeds to step 420.

In step 414, the lens shift vector is determined from the corresponding motion vector, for example by lens compensator 106 or optionally by motion compensator 104 (FIG. 1). In step 416, the voltage gradient matrix is generated corresponding to the lens shift vector. In step 418, the generated voltage gradient matrix is applied to adjustable lens 108 (FIG. 1), via contacts 204 (FIG. 2B).

In step 420, it is determined whether the image capture process is complete. If the image capture process is complete, step 420 proceeds to step 422 and the motion adjustment process is ended. If the image capture is not complete, however, step 420 proceeds to step 424 to increment the index and steps 404-420 are repeated.

FIG. 5 illustrates adjustable lens 108 disposed above image sensor 510 and included as part of imaging device 500. The image sensor includes microlens array 502, color filter array 504, and pixel array 506. Incoming light 508 is focused by adjustable lens 108, so that individual rays 508a, 508b, 508c and 508d strike pixel array 506 at different angles. These individual light rays emanate from the focal center of virtual lens 206 of adjustable lens 108, using motion adjustment system 100 (FIG. 1). Imaging device 500 may include a CMOS imager or a CCD imager. Although not shown, adjustable lens 108 may be included as part of a film camera.

FIG. 6 shows a typical processor-based system, designated generally as 600, which is modified to include motion adjustment system 100. The processor-based system 600, as shown, includes central processing unit (CPU) 602 which communicates with input/output (I/O) device 606, imaging device 500 and motion adjustment system 100 over bus 610. The processor-based system 600 also includes random access memory (RAM) 604, and removable memory 608, such as a flash memory. At least a part of motion adjustment system 100, CPU 602, RAM 604, and imaging device 500 may be integrated on the same circuit chip.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for capturing an image, the method comprising:
receiving light through an imaging lens having an adjustable focal center;
estimating a motion vector representing motion of the imaging lens;
estimating a shift vector in response to the motion vector;
converting the shift vector into a voltage gradient; and
providing the voltage gradient to the imaging lens,
wherein the focal center of the imaging lens is shifted based on the voltage gradient to compensate for the motion of the imaging lens.

2. The method according to claim 1, further comprising detecting the motion by a motion sensor,
wherein the detected motion by the motion sensor is used to estimate the motion vector.

3. The method according to claim 1, wherein the light is captured as the image, the method further comprising:
capturing multiple images in a sequence;
correlating the multiple images to detect the motion of the imaging lens,
wherein the detected motion from the correlated multiple images is used to estimate the motion vector.

4. The method according to claim 1, wherein the shift vector is estimated from a look-up table or from a predetermined relationship between the estimated motion vector and a predetermined motion compensation by the imaging lens.

5. The method according to claim 1, wherein the shift vector is estimated by predicting further motion of the imaging lens based on the estimated motion vector and at least one previously estimated motion vector, the focal center shifted to compensate for the predicted further motion.

6. The method according to claim 1, wherein the shift vector is converted into the voltage gradient using a look-up table or a predetermined relationship between the estimated shift vector and focusing parameters of the imaging lens.

7. The method according to claim 1, wherein the motion changes over time and the steps of estimating the motion vector, estimating the shift vector, converting the shift vector and providing the voltage gradient to the imaging lens are repeated over time to compensate for the change in the motion.

8. The method according to claim 1, the step of estimating the shift vector including:
determining whether a change in the estimated motion vector from a previously estimated motion vector is greater than a threshold;
maintaining a previously determined voltage gradient to the imaging lens when the change in the estimated motion vector is less than or equal to the threshold; and
estimating the shift vector in response to the estimated motion vector when the change in the estimated motion vector is greater than the threshold.

9. The method according to claim 1, further comprising, prior to transmitting the light through the imaging lens:
generating an initial voltage gradient based on focusing parameters of the imaging lens;
providing the initial voltage gradient to the imaging lens,
wherein the imaging lens is formed according to the focusing parameters and the light is transmitted through the imaging lens according to the focusing parameters.

10. The method according to claim 9, wherein the imaging lens is formed into a positive lens or a negative lens according to the focusing parameters.

11. The method according to claim 1, wherein the voltage gradient generates a directional electric field across the imaging lens and the imaging lens includes particles capable of being reoriented relative to the directional electric field, the voltage gradient provided to the imaging lens reorienting the particles relative to the directional electric field.

12. The method according to claim 11, wherein the directional electric field includes multiple directional electric fields, the particles being reoriented within corresponding regions of the imaging lens according to the multiple directional electric fields.

13. Apparatus for capturing an image, the apparatus comprising:
an imaging lens having an adjustable focal center;
a motion vector estimator for estimating a motion vector representing motion of the imaging lens;
a lens shift estimator for estimating a shift vector in response to the motion vector; and
a converter for converting the shift vector into a voltage gradient,
wherein the voltage gradient is provided to the imaging lens and adjusts the focal center of the imaging lens to compensate for the motion of the imaging lens.

14. The motion compensator according to claim 13, further comprising a plurality of contacts providing on opposing sides of the imaging lens in a regularly spaced or irregularly spaced arrangement, the plurality of contacts configured to apply the voltage gradient to the imaging lens.

15. The motion compensator according to claim 13, wherein the motion vector estimator includes a motion sensor to detect the motion of the imaging lens, the motion vector estimator using the detected motion used to estimate the motion vector.

16. The motion compensator according to claim 13, wherein the motion vector estimator receives multiple images in a sequence, the motion vector estimator configured to correlate the multiple images to detect the motion of the imaging lens and use the detected motion to estimate the motion vector.

17. The motion compensator according to claim 13, further comprising storage for storing at least one of the estimated motion vector, the estimated shift vector, a first look-up table for estimating the shift vector by the lens shift estimator, a second look-up table for converting the shift vector into the voltage gradient by the converter, a first predetermined relationship between the estimated motion vector and a predetermined motion compensation for estimating the shift vector by the lens shift estimator, a second predetermined relationship between the estimated shift vector and focusing parameters of the imaging lens for converting the shift vector by the converter or the voltage gradient received fro the converter.

18. The motion compensator according to claim 13, wherein the lens shift estimator predicts a further motion of the imaging lens based on the estimated motion vector and at least one previously estimated motion vector, the focal center being shifted to compensate for the predicted further motion.

19. The motion compensator according to claim 13, at least one of the lens shift estimator or the converter including a processor for estimating the shift vector or converting the shift vector into the voltage gradient, respectively.

20. The motion compensator according to claim 13, wherein the voltage gradient includes predetermined focusing parameters for the imaging lens, the imaging lens configurable as a negative lens or positive lens having the predetermined focusing parameters responsive to the voltage gradient.

21. The motion compensator according to claim 13, wherein the imaging lens includes particles in a polymer matrix that are responsive to the voltage gradient, the voltage gradient generating a directional electric field across the imaging lens, the directional electric field being reoriented relative to the directional electric field.

22. The motion compensator according to claim 21, wherein the directional electric field includes multiple directional electric fields, the particles being reoriented within corresponding sections of the imaging lens according to the multiple directional electric fields.

23. An imaging device comprising:
a pixel array,
an imaging lens for providing an image onto the pixel array,
the imaging lens including both a fixed real center and an adjustable virtual center,
a motion vector estimator for estimating a motion vector of either the imaging lens or the pixel array, and
a lens shift estimator for estimating a shift vector in response to the motion vector,
wherein the virtual center of the imaging lens is adjusted with respect to the real center based on the shift vector.

24. The imaging device of claim 23 wherein
the imaging lens is oriented in a first X, Y plane of an orthogonal X, Y, Z axes,
the pixel array is oriented in a second X, Y plane of the orthogonal X, Y, Z axes, and
the motion vector and the shift vector are both oriented in either the first or second X, Y plane.

25. The imaging device of claim 24 wherein
the real center is located on a first line oriented perpendicular to both the pixel array and the imaging lens, and
the virtual center is located on a second line oriented parallel to the first line.

26. The imaging device of claim 23 wherein
the real center is located on a first line oriented perpendicular to both the pixel array and the imaging lens, and
the lens shift estimator provides a voltage gradient across the imaging lens for shifting the virtual center with respect to the real center, the virtual center located on a second line oriented parallel to the first line.

27. The imaging device of claim 26 wherein
the imaging lens includes particles that are reoriented based on the voltage gradient provide across the imaging lens.

28. The imaging device of claim 23 wherein
the imaging lens and the pixel array are integrated in a single housing, and
at least one motion sensor is integrated into the housing for sensing motion of the housing and providing the sensed motion to the motion vector estimator.

29. The imaging device of claim 28 wherein
the lens shift estimator is configured to output the shift vector for adjusting the virtual center of the imaging lens only if the input sensed motion is greater than a predetermined threshold value.
